(19) United States
(12) Patent Application Publication
(10) Pub. No.: US 2021/0396025 A1
(43) Pub. Date: Dec. 23, 2021

(54) MODULAR FLOORING SYSTEM AND SUBFLOOR ASSEMBLY

(71) Applicant: PRATERS INCORPORATED, Chattanooga, TN (US)

(72) Inventors: David Gordon Smith, Chattanooga, TN (US); John Fitzgerald Prater, Rossville, GA (US)

(21) Appl. No.: 17/304,301

(22) Filed: Jun. 17, 2021

Related U.S. Application Data
(60) Provisional application No. 62/705,238, filed on Jun. 17, 2020.

(51) Int. Cl. E04F 15/22; E04F 15/02; E04F 15/10; A63C 19/00; B32B 3/06; B32B 5/18; B32B 21/04; B32B 25/04; B32B 3/14

(52) U.S. Cl. CPC E04F 15/225; B32B 2419/04; E04F 15/107; A63C 19/00; B32B 3/06; B32B 5/18; B32B 21/047; B32B 21/042; B32B 21/045; B32B 25/042; B32B 3/14; E04F 2290/044; B32B 2266/0278; B32B 2307/56; E04F 15/02038

(57) ABSTRACT

A modular flooring system for performance weightlifting and similar activities is provided. The modular flooring system is constructed from one or more individual flooring modules that are interlocked and connected together to provide a customized flooring surface platform. The modular flooring system can include a lifting platform module having a hardwood top surface layer and a subfloor construction. The modular flooring system can include a drop-zone platform module having a rubberized top surface layer and a subfloor construction designed to absorb and withstand the force impact of dropped weights onto the top surface layer. The subfloor construction of the drop-zone module can include an upper subfloor layer, an intermediate subfloor layer and a lower subfloor layer. The intermediate and lower subfloor layers can each including alternating panel sections with one panel section constructed from a foam-based material.

### CROSS-REFERENCE TO RELATED APPLICATIONS

This application claims priority to U.S. Provisional Patent Application Ser. No. 62/705,238, filed on Jun. 17, 2020, to David G. Smith et al., entitled “Modular Flooring System and Subfloor Assembly,” currently pending, the entire disclosure of which is incorporated herein by reference.

### BACKGROUND OF THE INVENTION

Weight training platforms and other performance flooring systems are often constructed from either hardwood surfaces or rubberized padded surfaces. In order to effectively withstand large force impacts, such as those from falling or dropped weights and other weight training objects, most platforms use exclusively a uniform layer of rubberized padded platform surfaces glued or attached to a rigid floor, typically concrete, that provides a single floor construction. However, the existing construction does not prove ideal because the dampening and spring action of the floor in the areas where the weights impact are not ideal for supporting the athlete as they perform their lift. A rigid surface, like a hardwood floor, may provide stability for the athlete, but does not handle the impact resistance and resilience required in a weight drop zone. Rubberized flooring glued to the hard surface may provide good impact absorption, but not the stability ideal to support the athlete. In addition, because hardwood surfaces and rubberized padded surfaces have different material and mechanical properties, both surfaces do not necessarily function similarly when applied to the same subfloor construction, such as those commonly used for hardwood subfloors. Accordingly, a need exists for an improved flooring system for weight-lifting platforms. Further, a need exists for a subfloor construction that can allow for the use of both rigid flooring, such as a hardwood surface, and rubberized surfaces within a single platform.

Further, it is often desirable for weight training platforms to be arranged in multiple sets or in large rows to allow for multiple users to train in a single location, such as athletic training facilities for high school, college, or professional teams. As a result, there is a need in the art for a weight-lifting platform system that is modular to allow for platforms to be easily customized and constructed into a desired configuration.

### BRIEF SUMMARY OF THE INVENTION

The present invention is directly generally toward a modular flooring system that can be constructed from one or more individual flooring modules to create a customized floor surface platform for use in a variety of different flooring applications, including without limitation, performance weightlifting flooring platforms. Each individual flooring module can include an upper or top surface layer and a subfloor construction provided below and/or secured to the top surface layer. The individual flooring modules can be configured to be interlocked and interconnected together in a variety of arrangements to provide a customized flooring system and/or platform.

The modular flooring system can include a lifting platform module, a drop-zone platform module, and a connecting module. The lifting platform module can include a performance hardwood top surface layer and a subfloor construction positioned below the top surface layer. According to one embodiment, the top surface layer of the lifting platform module can comprise engineered hardwood flooring. The subfloor construction of the lifting platform module can include an upper subfloor platform panel, a first layer of panels below the upper subfloor panel and extending in a first direction, and a second layer of panels below the first layer of panels and extending in a second direction.

The drop-zone platform module of the modular flooring system can include a top surface layer and a subfloor construction positioned below the top surface layer. The top surface layer of the drop-zone platform module can comprise a rubberized, rubber-based, synthetic or other material(s) configured to provide a resilient and impact-absorbing surface. According to one embodiment, the drop-zone platform module can include a padded layer provided below and secured to the top surface layer to increase resilient and impact-absorbing properties for receiving and withstanding forceful impacts from weights used in connection with weightlifting platforms.

The subfloor construction of the drop-zone platform module can include an upper subfloor platform panel extending continuously across the drop-zone platform module and below the top surface layer and/or padded layer. The subfloor construction can further include a first intermediate subfloor layer positioned below the upper subfloor platform panel, and a second lower subfloor layer positioned below the first intermediate subfloor layer. Both the first intermediate subfloor layer and the second lower subfloor layer can include a series of alternating panel sections extending across the drop-zone platform module and subfloor construction. The alternating panel sections can include a first panel section constructed from dimensional lumber, plywood or other multi-layer material, and a second panel section constructed from a foam or rubber-based material, including without limitation, a high density foam material, polyester-based urethane foam material, or other material impact absorption or rebound resilience properties.

The first and second panel sections can be arranged in an alternating arrangement across both the first intermediate subfloor layer and the second lower subfloor layer. According to one embodiment, the first panel sections in the first intermediate subfloor layer are positioned directly above the second panel sections in the second lower subfloor layer, and the second panel sections in the first intermediate subfloor layer are positioned directly above the first panel sections in the second lower subfloor layer. The resulting alternating arrangement of the first intermediate subfloor layer and second lower subfloor layer can function to deaden the sound and bounce rate of weights that are dropped by the user of the modular flooring system containing the drop-zone platform module.

The connecting module of the modular flooring system can include a top surface layer and a subfloor construction positioned below the top surface layer. Depending on the particular embodiment, the top surface layer can comprise hardwood flooring or a rubberized, synthetic or other material. The subfloor construction of the connecting module can be configured similar to the lifting platform module and can include an upper subfloor platform panel, a first panel layer, and a second panel layer. The connecting module can be configured to be positioned between arranged sets of modular platforms formed by the lifting platform modules and drop-zone platform modules in a configured flooring system.

The platform modules can be interconnected together in various arrangements to form a modular flooring system. Each individual platform module can be configured with an overhanging portion, a block tongue portion, or both to connect two individual platform modules together. According to certain embodiments, the drop-zone platform module can include an overhanging perimeter portion provided in the subfloor construction that extends beyond and overhangs the outer edge of the lower subfloor layers. Additionally, according to certain embodiments, the lifting platform module can include a solid block tongue provided in the subfloor construction along the first and second lower subfloor layers. The block tongue of the lifting platform module can be configured to be received by the overhanging portion of the drop-zone platform module to interconnect the two platform modules together. This configuration can enable multiple individual platform modules to be interconnected together in any desired arrangement to provide the modular flooring system.

### DESCRIPTION OF THE SEVERAL VIEWS OF THE DRAWINGS

In the accompanying drawings, which form a part of the specification and are to be read in conjunction therewith in which like reference numerals are used to indicate like or similar parts in the various views:

FIG. 1 is a perspective view of a modular weightlifting platform flooring system in accordance with one embodiment of the present invention;

FIG. 2 is a perspective view of the modular weightlifting platform flooring system of FIG. 1 illustrating different top surfaces in accordance with one embodiment of the present invention;

FIG. 3 is a perspective view of a modular flooring system including multiple weightlifting platforms in accordance with one embodiment of the present invention;

FIG. 4 is a top view of a modular flooring system including multiple weightlifting platforms in accordance with another embodiment of the present invention;

FIG. 5 is a schematic side elevation view of a hardwood surface platform module of a modular weightlifting platform flooring system in accordance with one embodiment of the present invention;

FIG. 6 is a schematic side elevation view of a drop-zone platform module of a modular weightlifting platform flooring system in accordance with one embodiment of the present invention;

FIG. 7 is a schematic side elevation view of a connecting module of a modular weightlifting platform flooring system in accordance with one embodiment of the present invention;

FIG. 8 is a schematic top plan view of the connecting module of FIG. 7;

FIG. 9A is a schematic side elevation view of the hardwood surface platform module of FIG. 5 and the drop-zone platform module of FIG. 6, illustrating the modules being interconnected together to form the modular weightlifting platform flooring system; and

FIG. 9B is a schematic side elevation view of the modular weightlifting platform flooring system of FIG. 9A, illustrating the modular weightlifting platform flooring system after the hardwood surface platform module and drop-zone platform module are interconnected.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

The following detailed description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. It will be appreciated that some or all of the various features and structures described and shown with respect to each of the specific embodiments referenced herein may be combined to form additional or alternative embodiments having such combinations and that such combinations are within the scope of the present invention.

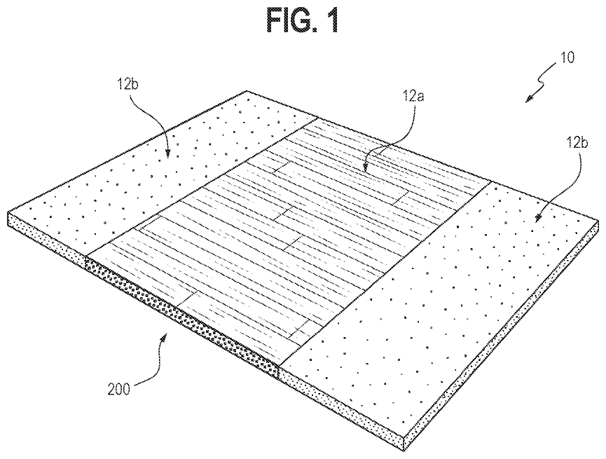

Referring to the several figures, the present invention is directed toward a modular flooring system 10 (a best illustrated in FIGS. 1, 3 and 4) that can be constructed from any number of individual flooring modules 12 to create a customized floor surface platform. In addition, the present invention is directed toward a subfloor construction 100 for an individual flooring module 12 to be used within module flooring system 10 in order to provide a stable interconnected flooring system 10 for a variety of different flooring applications, including without limitation, performance weightlifting flooring platforms.

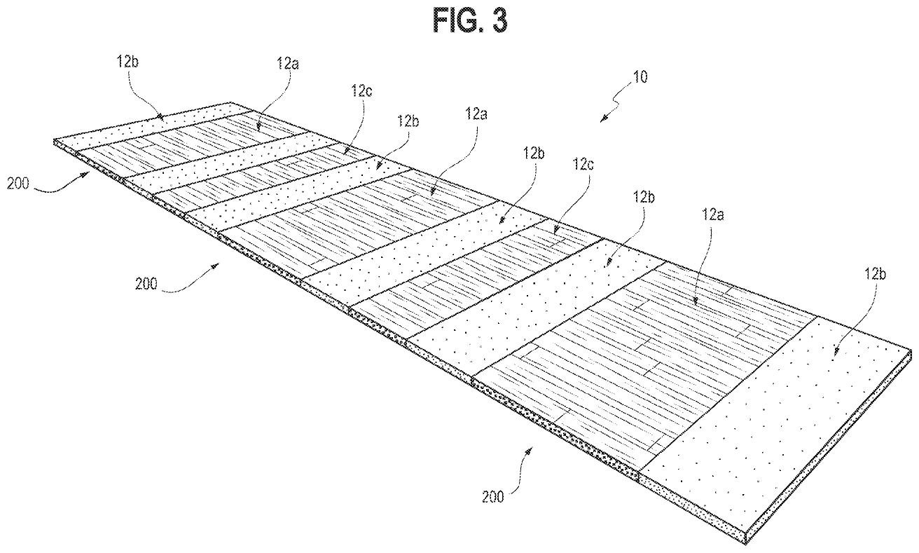

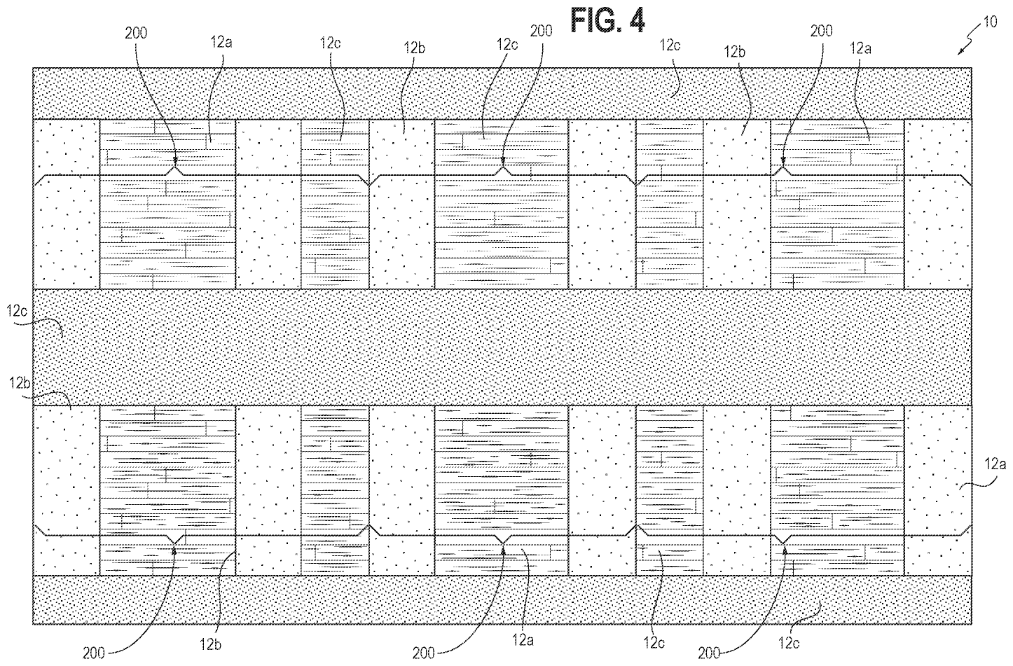

As shown in the several figures, modular flooring system 10 can include any quantity, configuration, combination and arrangement of individual flooring modules 12a, 12b, and 12c to provide a performance flooring surface and platform suitable for activities such as weightlifting and other activities and applications. As best shown in FIG. 1, modular flooring system 10 can be configured to provide a single performance lifting or weight-lifting platform 200. Modular flooring system 10 in such a configuration can operate as a standalone performance lifting or weight-lifting platform and can be constructed from a flooring module 12a connected to two flooring modules 12b. As best shown in FIGS. 3 and 4, modular flooring system 10 can be configured to provide multiple platforms 200 in a sequential, series or other suitable or desired arrangement to provide a customized floor surface. Modular flooring system 10 in such a configuration can operate as a series of interlocked or interconnected performance lifting or weight-lifting platforms 200 in a unique desired arrangement and can be constructed from multiple flooring modules 12a, 12b, and 12c. It is also recognized that any desired customizable arrangement for the modular flooring system 10 or individual platform 200 may be constructed in accordance with the present invention.

As best shown in FIGS. 1-4, according to certain embodiments, modular flooring system 10 can be used to construct a customized floor surface platform with one or more performance lifting platforms or weight-lifting platforms 200 having both hardwood standing sections and weight drop zones, along with non-platform sections (see FIG. 4). It is also recognized that modular flooring system 10 and the individual flooring modules 12 described herein can be used in any number of different flooring applications and can be constructed in different arrangements depending on the desired application.

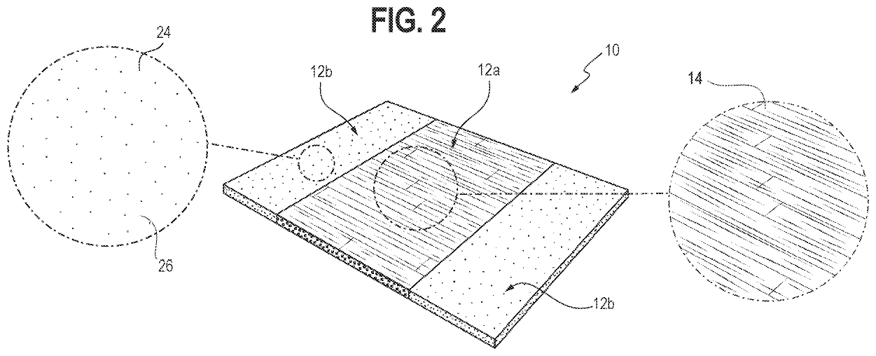

As further shown in FIGS. 1-4, modular flooring system 10 can include one or more individual flooring modules 12 that collectively comprise modular flooring system 10. The individual flooring modules 12 can include a hardwood lifting platform module 12a and a drop-zone platform module 12b interconnected together (as described in greater detail below) to form module flooring system 10 into a performance weightlifting platform 200. As best shown in FIGS. 1 and 2, a drop-zone platform module 12b can be provided along each end of a hardwood lifting platform module 12a to form the modular flooring system 10 into an individual weightlifting platform. The hardwood lifting platform module 12a can provide a stable hardwood surface for users to stand and perform weightlifting maneuvers while the drop-zone platform modules 12b can provide surface suitable for receiving dropped or lowered weights used by a user of the platform. In addition, as shown in FIGS. 3 and 4, multiple performance weightlifting platforms 200 can be constructed together from the platform modules 12a and 12b and spaced apart by connecting modules 12c. Each flooring module 12 can include subfloor construction (described in greater detail below) to support the tops surface of the module 12 and a tongue and groove connection means to allow for stable and secure interlocking of two or more modules 12 together to form a modular flooring system 10, such as a weightlifting platform or a plurality of weightlifting platforms.

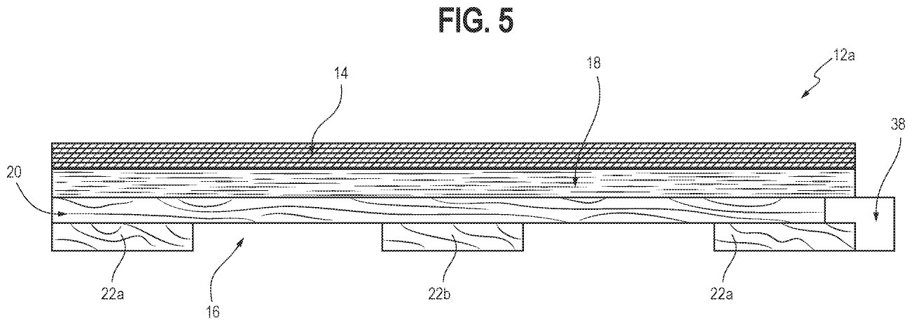

As best shown in FIG. 5, hardwood lifting platform module 12a can include a performance hardwood top surface layer 14 and a subfloor construction 16 positioned below top surface layer 14. According to one embodiment, top surface 14 of module 12a can comprise engineered hardwood flooring; however, it is recognized that top surface 14 may be constructed from any suitable hardwood or other similar performance flooring material, including without limitation, non-hardwood materials.

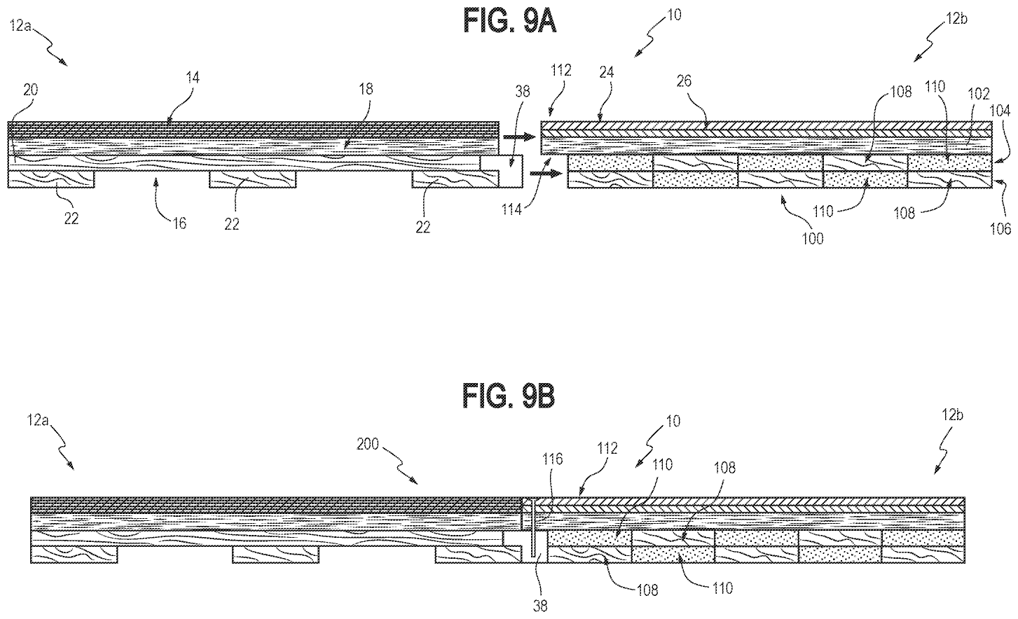

As further shown in FIGS. 5, 9A and 9B, the subfloor construction 16 of module 12a can include an upper subfloor platform panel 18 spanning across the module 12a, a first layer of panels 20 extending a first direction across module 12a below the upper subfloor panel 18, and a second layer of panels 22 extending a second direction across module 12a below the first layer of panels 20. In one embodiment, the first layers of panels 20 and the second layer of panels 22 are perpendicular, though other orientations are within the scope of the present invention. When subfloor construction 16 is constructed (as shown in FIG. 5), the upper platform panel 18, first layer of panels 20 and second layer of panels 22 are provided in a stacked arrangement thereby allowing some flexure in the panels 20 as they span between panels 22, which generally bear on the floor surface. Upper subfloor platform panel 18 can be constructed from a sheet of plywood or other multi-layer material, such as CDX or better grade, OSB, MDF, HDMDF, or any other suitable material, including without limitation, wood and/or composite materials. According to the embodiment shown in the figures, upper subfloor platform panel 18 can also have a thickness of approximately one inch; however, it is recognized a greater or lesser thickness can also suitably be used depending on the particular application.

Similarly, first and second subfloor layer panels 20 and 22 can be constructed from plywood or other multi-layer material, such as CDX or better grade, OSB, MDF, HDMDF, or any other suitable material, including without limitation, wood and/or composite materials. According to the embodiment shown in the figures, first and second subfloor panels 20 and 22 can also have a thickness of approximately ¾ inch; however, it is recognized a greater or lesser thickness can also suitably be used depending on the particular application. It is further recognized that subfloor construction 16 of module 12a can be constructed and configured in any manner currently known for performance hardwood floors.

As best shown in FIG. 5, first subfloor layer 20 of subfloor construction 16 may include a plurality of spaced first layer panels 20 extending in one direction (e.g., longitudinally) across the module 12a and beneath upper subfloor panel 18, and second subfloor layer 22 of subfloor construction 16 may include a plurality of spaced second layer panels 22 extending in the opposing direction (e.g., laterally) across the module 12a beneath first layer panels 20. The plurality of first layer panels 20 can be positioned in a spaced arrangement to provide a row of individual panels 20 extending in the longitudinal direction across subfloor construction 16. The plurality of second layer panels 22 can be positioned in a spaced arrangement to provide a row of individual panels 20 extending in the opposite or lateral direction across subfloor construction 16. As a result, first and second subfloor layers 20 and 22 can provide a grid configuration within subfloor construction 16. Both outer first layer panels 20a and outer second layer panels 22a can be provided along the perimeter of module 12a and subfloor construction 16 and one or more interior first layer panels 20b and second layer panels 22b may be intermediately spaced therebetween at a desires spacing.

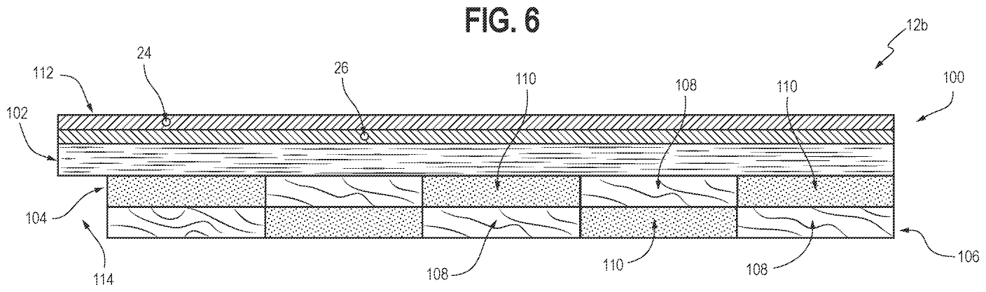

As shown in FIGS. 6, 9A and 9B, drop-zone platform module 12b can include a top surface layer 24 and a subfloor construction 100 provided below top surface layer 24. Top surface layer 24 can configured as an exposed top surface layer to provide a resilient wearing surface to resist tears, scratches, or other damage. In one embodiment, top surface layer 24 covers the entire area of the drop-zone platform module 12b. Top surface layer 24 may comprise any suitable rubberized, rubber-based, synthetic or other material(s), including without limitation, the surface layer materials designed and manufactured by Mondo Sport & Flooring. According to one embodiment, top surface layer 24 comprises a Mondo rubberized surface layer commonly used on weight training-style platforms and the similar applications. In addition, beneath the top surface layer 24 can be a padded rubber layer 26 which provides an impact absorption and resilient properties. Collectively, layers 24 and 26 can provide a padded, shock absorbing surface suitable for providing a resilient wearing surface and receiving and withstanding forceful impacts from weights used in connection with weightlifting platforms. In one embodiment, layers 24 and 26 can be combined into a single thickness of one material or a laminated two-layer flooring material.

FIGS. FIGS. 6, 9A and 9B illustrate subfloor construction 100 for module 12b according to one embodiment of the present invention. As shown, subfloor construction 100 can include an upper subfloor platform panel 102 that extends continuously across module 12b and beneath top surface layer 24 and padded layer 26. Upper subfloor platform panel 102 can comprise a sheet of plywood or other multi-layer material, such as CDX or better grade, OSB, MDF, HDMDF, or other suitable material. According to the embodiment shown in the figures, upper subfloor platform panel 102 can have a thickness of approximately one inch; however, it is recognized that any suitable thickness can be used depending on the desired configuration and application.

Subfloor construction 100 can further include a first intermediate subfloor layer 104 and a second lower subfloor layer 106 positioned in a stacked arrangement below upper subfloor panel 102. As shown in FIG. 6, both first and second subfloor layers 104 and 106 can comprise a series of alternating panel sections 108 and 110 extending in one direction (e.g., longitudinally or laterally) across module 12b and subfloor construction 100. As best shown in FIG. 6, panel sections 108 can be provided in an equally spaced configuration with panel sections 110 provided in a similar equally spaced configuration between adjacent panel sections 108. This configuration forms both first and second subfloor layers 104 and 106 as continuous and subfloor layers spanning across the entirety of subfloor construction 100 and module 12b. In certain embodiments, panel section 108 may be positioned directly adjacent to one another when arranged to form the first and second subfloor layers 104 and 106 so that subfloor layers 104 and 106 span across subfloor construction 100 in a continuous or near continuous configuration. In such embodiments, alternating panel sections 108 and 110 that are adjacent to one another can be positioned into direct contact or near contact with one another so that no significant spaces or gaps are provided between the two adjacent panel sections 108 and 110. It is also recognized that a number of different arrangements and configurations of panel sections 108 and 110 may be used in alternative embodiments of subfloor construction 100.

As further shown in FIG. 6, the panel sections 108 and 110 of first and second subfloor layers 104 and 106 can be provided in an alternating arrangement so that a panel section 108 in first subfloor layer 104 is positioned above a panel section 110 in second subfloor layer 104 so that two of the same panel sections (either 108 or 110) are not stacked on top of one another. In this configuration, a panel section 108 of intermediate or first subfloor layer 104 can be located directly or almost directly above a panel section 110 of the lower or second subfloor layer 106 (rather than another panel section 108). In one embodiment, the more rigid panel section 108 is always either above or below the more flexible or impact absorbing panel section 110.

According to one embodiment, panel sections 108 may comprise dimensional lumber, plywood or other multi-layer material (such as CDX, OSB, MDF, or HDMDF), while panels sections 110 may comprise a high density foam material, such or polyester-based urethane or similar-type of material having properties and characteristics similar to commonly used foam materials. Sections 110 may be made from a rebound foam material or any other foam or rubber material providing impact absorption and resiliencies required for use in a weight platform. According to one embodiment, panel sections 108 and 110 (and thus first and second subfloor layers 104 and 106) can have a thickness of approximately ¾ inch; however, it is recognized that any suitable thickness can be used depending on the desired configuration and application.

As shown in FIGS. 6, 9A and 9B, once subfloor construction 100 is constructed, second lower subfloor layer 106 may be positioned directly below and secured to first intermediate subfloor layer 104, and first intermediate subfloor layer 104 can be positioned directly below and secured to upper subfloor platform panel 102. Subfloor construction 100 may then be provided directly below and secured to top surface layer 24 and padded layer 26 to form platform module 12b. Collectively, the alternating and stacked panel sections 108 and 110 of the first and second subfloor layers 104 and 106 create a stable subfloor construction for drop-zone platform module 12b that can absorb and withstand the force impact of dropped weights onto the top surface layer 24 when module 12b is used in connection with module 12a to form a weight-lifting modular platform 10. Further, the alternating and stacked panel sections 108 and 110 can function to deaden the sound and bounce rate of weights that are dropped by the user of the modular platform 10 containing module 12b.

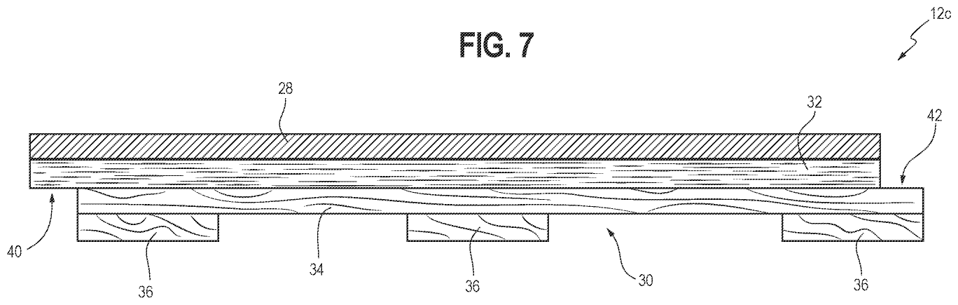

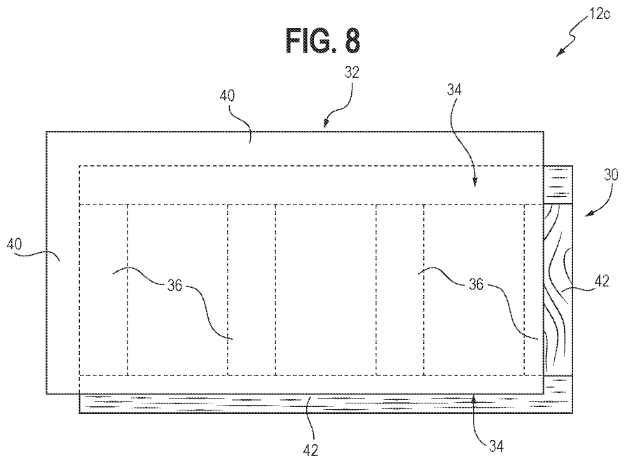

FIGS. 7 and 8 illustrate the configuration of connecting modules 12c that can be used in a modular flooring system 10 in connection with platform modules 12a and 12b. In one embodiment, modules 12a, 12b, and 12c have the same overall thickness to provide a uniform surface. As shown in FIG. 4, connecting modules 12c can operate a spacer sections between weightlifting platforms formed from modules 12a and 12b. As shown in FIG. 7, connecting module 12c can include a top surface layer 28 constructed from any suitable material, including without limitation, a rubberized material. As best shown in FIG. 3, connecting module 12c may have an appearance and construction similar to module 12a, so that a hardwood surface is provided. Additionally, as shown in FIG. 4, connecting module 12c may have an appearance and construction similar to module 12b, so that a rubberized or softer surface is provided. In one embodiment, connecting module 12c may generally be constructed on top of a subfloor construction 30 configured similarly to subfloor construction 16 of module 12a. As shown in FIG. 7, subfloor construction 30 can include an upper panel layer 32 comprising a plywood or similar multi-layer material, a first lower subfloor layer 34 comprising spaced panels extending in a first direction, and a second lower subfloor layer 36 comprising spaced panels extending in a second direction perpendicular to the first subfloor layer 34. The panels of first lower subfloor layer 34 and second lower subfloor layer 36 may be arranged in opposing directions or perpendicular (i.e., longitudinally and laterally) in a spaced configuration as best illustrated in FIG. 8. Such configuration may be similar to the arrangement of first layer panels 20 and second layer panels 22 in the subfloor construction 16 of module 12a described above.

As best shown in FIGS. 9A and 9B, platform modules 12a and 12b can be interconnected together to form modular flooring system 10 as a modular platform 200. As best shown in FIG. 9A, upper subfloor platform panel layer 102 of subfloor construction 100 for drop-zone module 12b can include an overhanging perimeter portion 112 that extends beyond and overhangs the outer edge of first and second subfloor layers 104 and 106 and forms a groove portion 114. As further shown in FIG. 9A, the subfloor construction 16 of hardwood module 12a can include a solid block tongue 38 positioned along the outer perimeter edge of the first and second subfloor layers 20 and 22 of subfloor construction 16. Solid block tongue 38 can be constructed from any suitable solid material, including without limitation, wood and/or composite materials. As also shown in FIGS. 9A and 9B, tongue 38 can extend along the entire height of first and second subfloor layers 20 and 22 so that the bottom of tongue 38 is flush with the bottom of second subfloor layer 22. Solid block tongue 38 generally is continuous along the sides of the panels being connected, but alternatively could be intermittent and underlap only portions of the sides of the modules 12b that are connected to module 12a or connecting module 12c.

As further shown in FIGS. 9A and 9B, in order to connect modules 12a and 12b together, the overhanging perimeter portion 112 of module 12b subfloor construction 100 can be placed into an overlapped relationship with solid block tongue 38 of module 12a subfloor construction 16 so that the edge of upper subfloor platform panel layer 102 of subfloor construction 100 abuts upper subfloor platform panel layer 18 of subfloor construction 100. In addition, solid block tongue 38 can be received within the groove portion 114 of subfloor construction 100 and can abut the remainder of subfloor construction 100 (i.e., overhanging perimeter portion 112 and first and second subfloor layers 104 and 106). A fastener 116 can further be used to securely attached subfloor construction 100 to the solid block tongue 38 and secure modules 12a and 12b together. Fastener 116 can comprise a fastener, pin, screw, bolt, or other suitable fastening mechanism known in the art.

As best shown in FIGS. 9A and 9B, drop-zone platform module 12b can include an overhanging perimeter portion 112 (and corresponding groove 114) along each side configured to be interconnected to a hardwood surface platform module 12a. As further shown in FIGS. 9A and 9B, hardwood surface platform module 12a can include a tongue portion 38 extending along each side configured to be interconnected to a drop-zone platform module 12b. The resulting arrangement can enable multiple hardwood surface platform modules 12a and multiple drop-zone platform modules 12b to be interconnected together to form a modular flooring system 10 with multiple weightlifting platforms contained therein.

As further shown in FIGS. 7 and 8, non-platform modules 12c can be configured similarly with overhanging perimeter portions 40 and perimeter shelf portions 42 provided along the outer perimeter edges of modules 12c in order to allow modules 12c to be interconnected with modules 12a and 12b within modular flooring system 10. It is also recognized that all exterior perimeter edges of modules 12a, 12b, and 12c that are not interlocked with another module 12 are not required to include an overhanging portion 112/40 or tongue 38 or shelf portion 42 and can include a defined edge where the top surface and subfloor construction are aligned.

While not illustrated in the figures, in certain embodiments of the present invention, modular flooring system 10 may be configured with one or more means for enabling the movement, transport, repositioning and portability of modular flooring system 10. In such embodiments, one or more of platform modules 12a, 12b, and 12c may be configured with rollers, wheels, or other suitable means for enabling each individual platform module 12, or a constructed modular flooring system 10 to be selectively moved to transported along a floor or similar surface. The rollers, wheels or transport means may be attached or connected to the subfloor construction 16 of platform module 12a, subfloor construction 100 of platform module 12b, and/or subfloor construction 30 of platform module 12c.

In an alternative embodiment, one or more of platform modules 12a, 12b, and 12c may be connected to adjacent platform modules 12a, 12b, and 12c using a hinge connection so that the modular flooring system 10 can be used in a temporary location and easily folded up and moved out of the way or stored up against a wall when not in use.

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention.

What is claimed is:

1. A modular flooring system comprising:
a first platform module comprising a first top surface and a first subfloor construction; and
a second platform module comprising a second top surface and a second subfloor construction, wherein the second subfloor construction comprises:
an upper subfloor platform panel positioned below and secured to the second top surface;
an intermediate subfloor panel section positioned beneath the upper subfloor platform panel; and
a lower subfloor panel section positioned beneath the intermediate subfloor panel section;
wherein the intermediate subfloor panel section and the lower subfloor panel section each comprise alternating first and second panels extending in a longitudinal direction, wherein the first panel comprises a multi-layer wood-based or composite material and the second panel comprising a foam-based material.

2. The modular flooring system of claim 1, wherein the first and second platform modules are connected together to form a weightlifting platform.

3. The modular flooring system of claim 1, wherein the first platform module includes a solid block tongue provided along at least one side thereof and the second platform module includes an overhanging perimeter edge portion provided along at least one side thereon and forming a groove beneath the overhanging perimeter edge portion, wherein the tongue and groove on the first and second platform module provide interlocking means for connecting the first and second platform modules together.

4. The modular flooring system of claim 1, wherein the first top surface comprises an engineered hardwood material.

5. The modular flooring system of claim 4, wherein the second top surface comprises a rubberized material.

6. The modular flooring system of claim 1, wherein the first panel in the intermediate and lower subfloor panel sections comprises plywood, CDX, OSB, MDF, or HDMDF.

7. The modular flooring system of claim 1, wherein the second panel in the intermediate and lower subfloor panel section comprises high density urethane foam material.

8. The modular flooring system of claim 1, wherein one or more first platform modules and one or more second platform modules are configured for being connected together to provide one or more weightlifting platforms.

9. The modular flooring system of claim 1, wherein the alternating first and second panels in the intermediate subfloor panel section are positioned directly adjacent to one another to form a generally continuous intermediate subfloor panel section within the second subfloor construction.

10. The modular flooring system of claim 9, wherein the alternating first and second panels in the lower subfloor panel section are positioned directly adjacent to one another to form a generally continuous lower subfloor section within the second subfloor construction.

11. The modular flooring system of claim 1, wherein at least one first panel in the intermediate subfloor panel section is positioned directly above a second panel in the lower subfloor panel section.

12. The modular flooring system of claim 11, wherein each first panel in the intermediate subfloor panel section is positioned directly above a second panel in the lower subfloor panel section.

13. A flooring module for a weight-lifting platform, the flooring module comprising:
a top surface layer; and
a subfloor construction positioned below the top surface layer, the subfloor construction comprising:
an upper subfloor platform panel positioned below and secured to the top surface layer;
an intermediate subfloor panel section positioned below the upper subfloor platform panel; and
a lower subfloor panel section positioned below the intermediate subfloor panel section;
wherein the intermediate subfloor panel section and the lower subfloor panel section each comprise alternating first and second panels extending in a longitudinal direction, wherein the first panel comprises a multi-layer wood-based or composite material and the second panel comprising a foam-based material.

14. The flooring module of claim 13, wherein top surface layer comprises a rubberized material.

15. The flooring module of claim 13, wherein the second panel in the intermediate subfloor panel section and the lower subfloor panel section comprises high density urethane foam material.

16. The flooring module of claim 13, wherein the lower subfloor panel section is positioned directly below and secured to the intermediate subfloor panel section, and wherein the intermediate subfloor panel section is positioned directly below and secured to the upper subfloor platform panel.

17. A modular weight-lifting platform comprising:
a first platform module comprising a first top surface layer and a first subfloor construction, wherein the first top surface layer comprises an engineered hardwood material; and
a second platform module comprising a second top surface layer and a second subfloor construction, wherein the second subfloor construction comprises:
an upper subfloor platform panel positioned below and secured to the second top surface layer;
an intermediate subfloor panel section positioned beneath the upper subfloor platform panel; and
a lower subfloor panel section positioned beneath the intermediate subfloor panel section;
wherein the intermediate subfloor panel section and the lower subfloor panel section each comprise alternating first and second panels extending in a longitudinal direction, wherein the first panel comprises a multi-layer wood-based or composite material and the second panel comprising a foam-based material;
wherein the first subfloor construction of the first platform module includes a solid block tongue configured to be received by an overhanging perimeter edge portion of the second subfloor construction of the second platform module to selectively interlock and connect the first platform module and the second platform module together.

18. The modular weight-lifting platform of claim 17, wherein the second top surface layer comprises a rubberized material.

19. The modular weight-lifting platform of claim 17, wherein the alternating first and second panels in the intermediate subfloor section are positioned directly adjacent to one another to form a generally continuous intermediate subfloor section within the second subfloor construction.

20. The modular weight-lifting platform of claim 17, wherein at least one first panel in the intermediate subfloor section is positioned directly above a second panel in the lower subfloor panel section.
